(19) United States
(12) Patent Application Publication
(10) Pub. No.: US 2012/0020125 A1
(43) Pub. Date: Jan. 26, 2012

(54) VOLTAGE REGULATOR FOR FUEL CELL AND METHOD THEREFOR

(75) Inventors: Yu-Jen Chen, Taoyuan (TW); Chi-Bin Wu, Taoyuan (TW)

(73) Assignee: Chung-Hsin Electric and Machinery Manufacturing Corp., Jhonghe City (TW)

(21) Appl. No.: 12/915,846

(22) Filed: Oct. 29, 2010

(30) Foreign Application Priority Data
Jul. 21, 2010 (TW) 099124057

(51) Int. Cl. H02M 7/493

(52) U.S. Cl. 363/71

(57) ABSTRACT

A voltage regulator for a fuel cell and a method therefor are disclosed. Inputs of converters are connected to the fuel cell in parallel and outputs of the converters are connected between a positive terminal and a negative terminal of a load in series. The output of the fuel cell is converted by the converters and combined to output as an output voltage, which is provided to the load as a working voltage of the load. A control circuit in the voltage regulator receives a feedback signal related to the output voltage to feedback control the converters, such that each converter outputs the same constant voltage.

### BACKGROUND OF THE INVENTION

1. Technical Field

The present invention relates to power supply systems for fuel cells, and more particularly, to a voltage regulator for a fuel cell and a voltage-regulating method for a fuel cell.

2. Description of Related Art

As a device for converting chemical energy into electric energy by way of electrochemical reaction, a fuel cell works upon delivering hydrogen-based fuel and an oxidant (air or oxygen) to its positive pole and negative pole, wherein the positive pole serves to decompose the fuel into hydrogen ions and electrons, in which the hydrogen ions proceed from the positive pole to the negative pole through a proton exchange membrane, and then react into water with the electrons that have been transferred to the negative pole through an external circuit. Thereby, the fuel cell can ceaselessly supply electricity provided the fuel is continuously supplied.

As compared with the traditional power-generation technologies, fuel cells possess the advantages of low pollution, low noise, high energy density and good energy conversion efficiency, thus being a frontier energy source. Currently, fuel cells have been extensively applied in various sectors, such as electricity, industry, transportation, space technology, military use and so on.

The process of power supply in a fuel cell involves many parameters such as fuel concentration, reaction temperature, fuel transfer and electron flow, and thus a fuel cell has its output significantly subject to a load associated thereto. After establishment of connection between a fuel cell and a load, the terminal voltage of the fuel cell greatly varies with current variation of the load, with a variation up to 50%. Therein, the greater the current of the load is, the greater the voltage variation of the fuel cell is.

For this reason, in practice, it is seldom to use the voltage output by a fuel cell directly. Instead, the voltage output from a fuel cell is first stabilized by means of power electronic technology, and then put into use. In other words, in view of the fact that the output voltage of a fuel cell tends to be unstable due to variation of an associated load and polarization loss of the fuel cell itself, a converter is typically implemented to stably convert the output voltage of the fuel cell for application.

In general, output power of fuel cells ranges between 1 kW and 10 kW. However, a converter for high-power output is uncompetitive because its parts are less available and its manufacturing process is relatively costly. Also, its nature of low voltage and high current adds difficulty in processing and may lead to electromagnetic interference.

### SUMMARY OF THE INVENTION

The present invention provides a voltage regulator for a fuel cell and a method therefor, wherein inputs of multiple converters are connected in parallel, so as not to make a converter solely receive a high-power input, thereby eliminating the need of a high-power converter that is costly and difficult to produce and may cause electromagnetic interference under a high current.

The present invention provides a voltage regulator for a fuel cell and a method therefor, wherein outputs of multiple converters are connected in series, so as to reduce the voltage ratio of every converter, thereby preventing amplified surges and non-linear vibration at the secondary side.

The present invention provides a voltage regulator for a fuel cell and a method therefor, wherein a unit controller ensures that every converter has the same output power, so as to prevent any of the combined converters from getting damaged by its excessive output power.

For achieving the aforementioned effects, the present invention provides a voltage regulator for a fuel cell, wherein the voltage regulator comprises: a plurality of converters, each having an input and an output, with the inputs electrically connected in parallel to the fuel cell, and with the outputs electrically connected in series between a positive terminal and a negative terminal of a load; and a control circuit for controlling the converters according to a working voltage of the load, so as to make each said converter output a same constant voltage.

For achieving the aforementioned effects, the present invention provides a voltage-regulating method for a fuel cell, wherein the voltage-regulating method comprises steps of using a plurality of converters to convert an output of the fuel cell into constant voltages; combining the constant voltages of the converters into an output voltage; and performing a feedback control step, wherein the converters are feedback controlled according to the output voltage, so as to make each said converter output a same constant voltage.

By implementing the present invention, at least the following progressive effects can be achieved:

1. By using the multiple converters with their inputs connected in parallel, the overall output power of the fuel cell can be evenly distributed, so as to prevent that any sole converter receives an input of excessively high power. Thereby converters for relatively small power can be adapted instead of a high-power converter that is costly and difficult to produce and may cause electromagnetic interference under a high current.

2. By using the multiple converters with their outputs connected in series, the overall output voltage can be increased while the voltage ratio of every converter module can be reduced, thereby preventing amplified surges and non-linear vibration at the secondary side.

3. In virtue of the internal control unit, every converter has equivalent output power, so as to prevent any of the combined converters from getting damaged by its excessive output power.

### BRIEF DESCRIPTION OF THE DRAWINGS

The invention as well as a preferred mode of use, further objectives and advantages thereof will be best understood by reference to the following detailed description of illustrative embodiments when read in conjunction with the accompanying drawings, wherein:

FIG. 1 is a schematic block diagram of a voltage regulator for a fuel cell according to the present invention;

FIG. 2 is a flowchart of a voltage-regulating method for a fuel cell according to the present invention;

FIG. 3 is a schematic block diagram of a control circuit according to a first embodiment of the present invention;

FIG. 4 is a schematic block diagram of a unit controller according to the first embodiment of the present invention;

FIG. 5 is a detailed flowchart of a feedback control step according to an embodiment of the present invention;

FIG. 6 is a detailed flowchart of Steps 453 and 455 according to an embodiment of the present invention;

FIG. 7 is a schematic block diagram of the control circuit according to a second embodiment of the present invention; and

FIG. 8 is a schematic block diagram of the unit controller according to the second embodiment of the present invention.

### DETAILED DESCRIPTION OF THE INVENTION

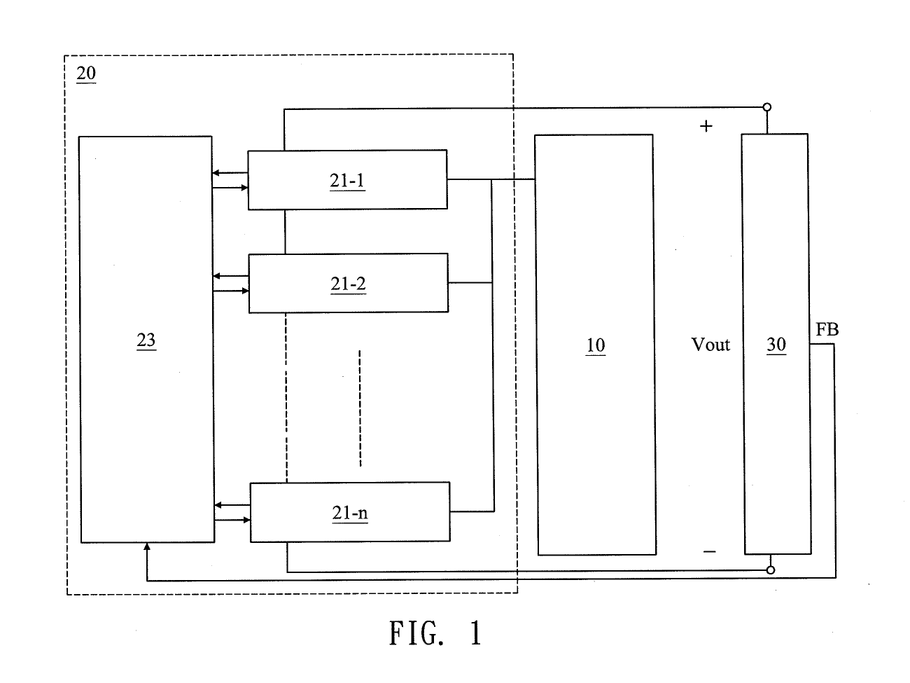

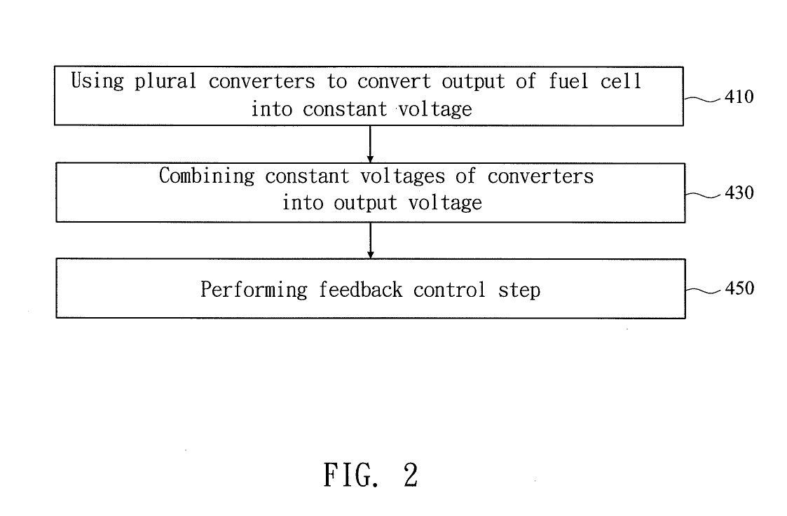

Referring to FIG. 1 and FIG. 2, the shown embodiment of the present invention is a voltage regulator 20 for a fuel cell 10. The voltage regulator 20 is connected between the fuel cell 10 and a load 30 and configured to stably convert an output of the fuel cell 10 for the load 30.

The voltage regulator 20 comprises multiple converters 21-1, 21-2˜21-n (each hereinafter respectively referred to as one said converter 21) and a control circuit 23.

Each said converter 21 has an input and an output. The converters 21-1, 21-2˜21-n have their inputs electrically connected in parallel to the fuel cell 10, for receiving the output of the fuel cell 10 equally. In other words, the overall output power of the fuel cell 10 is evenly distributed to the converters 21, so as to prevent that any single converter receives an excessively high power input. Thereby converters for relatively small power can be adapted instead of a high-power converter that is costly and difficult to produce and may cause electromagnetic interference under a high current.

The converters 21-1, 21-2˜21-n convert the output of the fuel cell 10 into constant voltages V1, V2˜Vn, respectively (Step 410).

The outputs of the converters 21-1, 21-2˜21-n are electrically connected in series between a positive terminal and a negative terminal of the load 30, so as to combine the constant voltages V1, V2˜Vn from the converters 21-1, 21-2˜21-n into an output voltage Vout (Step 430), which is provided to the load 30 as a working voltage of the load 30.

The control circuit 23 is electrically connected to the load 30 for controlling each said converter 21 according to the working voltage of the load 30, so that each said converter 21 outputs a same constant voltage. Therein, the output voltage Vout (the working voltage of the load 30) may be used as a feedback signal FB for the control circuit 23. In this case, the control circuit 23 receives the feedback signal FB and performs feedback control, wherein each said converter 21 is feedback controlled according to the output voltage Vout, so as to ensure that each said converter 21 outputs the same constant voltage (Step 450).

Thereby, each said converter 21 has the same output power, so as to prevent any of the combined converters 21-1, 21-2˜21-n from getting damaged by its excessive output power.

Therein, each said converter 21 may be a DC/DC converter.

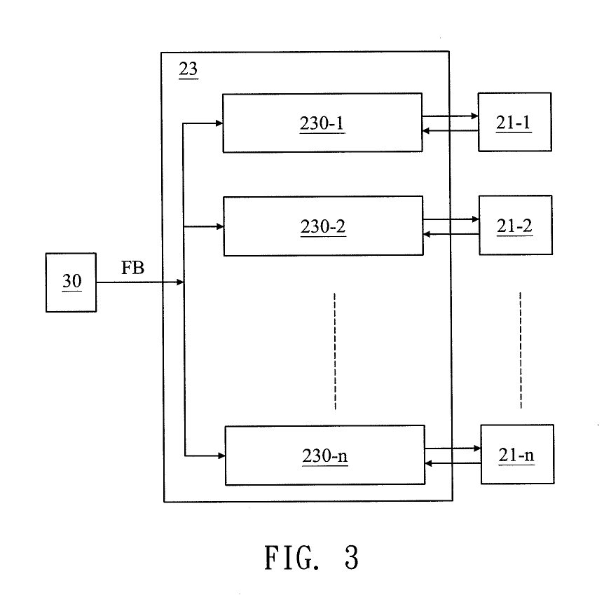

Referring to FIG. 3, the control circuit 23 may have multiple unit controllers 230-1, 230-2˜230-n (each hereinafter respectively referred to as one said unit controller 230).

The unit controllers 230-1, 230-2˜230-n correspond to the converters 21-1, 21-2˜21-n, respectively, and the unit controllers 230-1, 230-2˜30-n are electrically connected to the converters 21-1, 21-2˜21-n in a one-on-one manner. In addition, each said unit controller 230 and the corresponding converter 21 jointly form a converter module (not shown). In other words, each said converter module includes one said unit controller 230 and one said converter 21, so as to simplify the overall circuit configuration.

Each said unit controller 230 receives the feedback signal FB and feedback controls the corresponding converter 21 according to the output voltage Vout (the working voltage of the load 30), so as to ensure that each said converter 21 outputs the same constant voltage.

As each said unit controller 230 is configured approximately the same, for the sake of clear illustration, only the schematic structure of one unit controller 230-i is shown, where i is any positive integer between 1 and n.

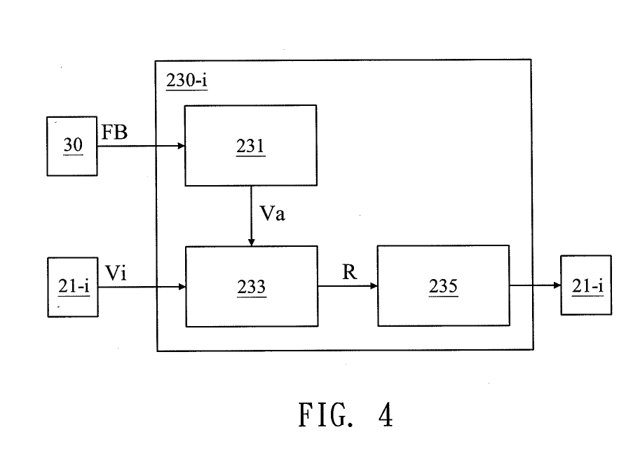

Referring to FIGS. 1 through 4, the unit controller 230-i may comprise a computing unit 231, a comparing unit 233 and an optional modulating unit 235. Therein, the computing unit 231 is electrically connected to the load 30, and the comparing unit 233 is electrically connected to the computing unit 231 and the output of the corresponding converter 21-i, while the optional modulating unit 235 is connected between an output of the comparing unit 233 and the corresponding converter 21-i.

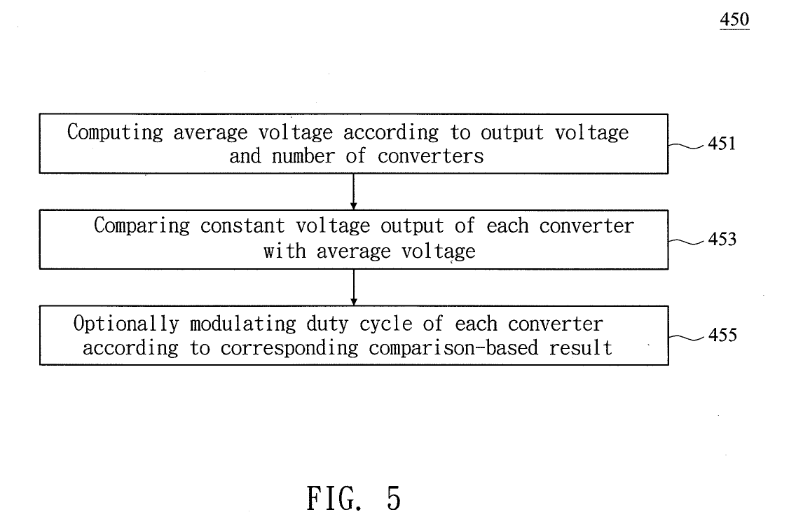

Also referring to FIG. 5, the computing unit 231 receives the feedback signal FB corresponding to the output voltage Vout (i.e., the working voltage of the load 30), and computes an average voltage Va according to the output voltage Vout (i.e., the working voltage of the load 30) and a number of the converters 21-1, 21-2˜21-n (n) (Step 451). Therein, the average voltage Va is derived from dividing the output voltage Vout by the number of the converters 21-1, 21-2˜21-n (n).

The comparing unit 233 of each said unit controller 230-i compares the average voltage Va and the constant voltage Vi from the respectively corresponding converter 21-i (Step 453), and sends a comparison-based result R to the respectively corresponding optional modulating unit 235.

The optional modulating unit 235 of each said unit controller 230-i performs an optional modulation step, wherein a duty cycle of the corresponding converter 21-i is modulated according to the comparison-based result R corresponding to each said converter 21 (Step 455).

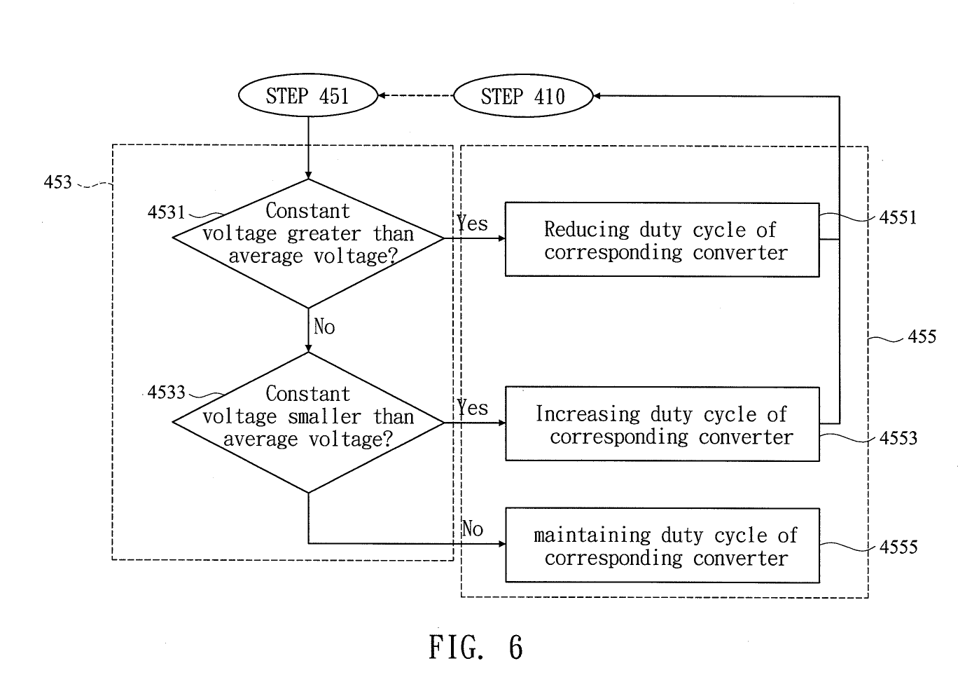

Further seeing FIG. 6, when the constant voltage Vi output by the corresponding converter 21-i is greater than the average voltage Va (Step 4531), the optional modulating unit 235 decreases the duty cycle of the corresponding converter 21-i (Step 4551), so as to decrease the constant voltage Vi output by the corresponding converter 21-i to the average voltage Va.

When the constant voltage Vi output by the corresponding converter 21-i is smaller than the average voltage Va (Step 4533), the optional modulating unit 235 increases the duty cycle of the corresponding converter 21-i (Step 4553), so as to increase the constant voltage Vi output by the converter 21-i to the average voltage Va.

When the constant voltage Vi output by the corresponding converter 21-i is equal to the average voltage Va, the optional modulating unit 235 maintains the duty cycle of the converter 21-i without change (Step 4555).

Therein, modulation of the duty cycle of the converter 21-i made by the optional modulating unit 235 of any said unit controller 230-i leads to the change of the output voltage Vout. Therefore, the computing unit 231 will recomputed the average voltage Va (Step 451), and the subsequent comparison will be performed until all the converters 21-1, 21-2˜21-n output the same constant voltage (V1, V2˜Vn).

Therein, the optional modulation step performed by the optional modulating unit 235 may be realized by using a PWM (Pulse Width Modulation) control mechanism to increase or decrease the duty cycle of the corresponding converter 21-i.

Moreover, while it is depicted in FIG. 6 that the constant voltage Vi is firstly determined as being greater than the average voltage Va or not (Step 4531), and then, if not, is determined as being smaller than the average voltage Va or not (Step 4533), the proceeding order is not limited to that described. Alternatively, the constant voltage Vi may be firstly determined as being smaller than the average voltage Va or not (Step 4533), and then, if not, determined as being greater than the average voltage Va or not (Step 4531). It is also feasible to determine whether the constant voltage Vi is greater than the average voltage Va and whether the constant voltage Vi is smaller than the average voltage Va at the same time (Step 4531 and Step 4533), and only when the both results are negative, the optional modulating unit 235 maintains the duty cycle of the converter 21-i (Step 4555).

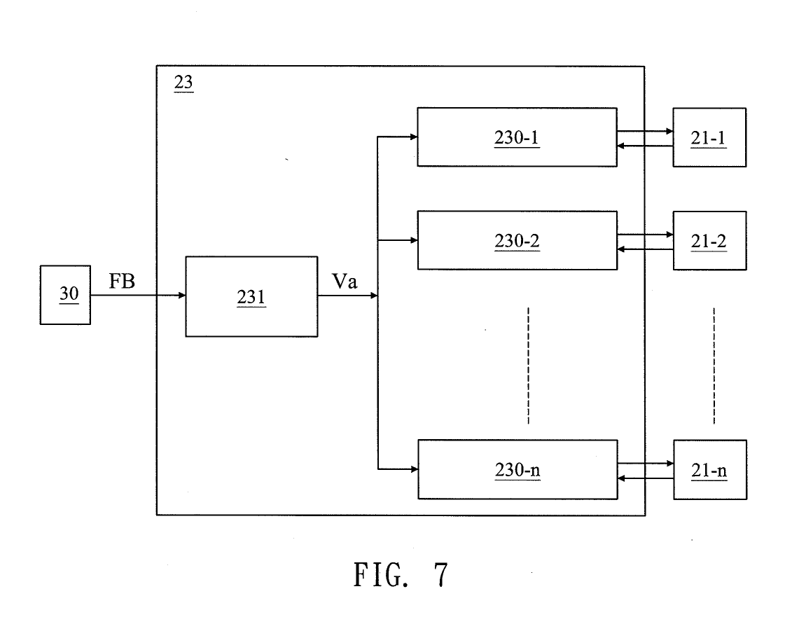

Referring to FIG. 7, in a second embodiment, the control circuit 23 may have multiple unit controllers 230-1, 230-2˜230-n and a computing unit 231.

The unit controllers 230-1, 230-2˜230-n correspond to the converters 21-1, 21-2˜21-n, respectively, and the unit controllers 230-1, 230-2˜230-n are electrically connected to the converters 21-1, 21-2˜21-n in a one-on-one manner. Therein, the computing unit 231 is electrically connected to the load 30, and an output of the computing unit 231 is electrically connected to each said unit controller 230. In addition, each said unit controller 230 and the corresponding converter 21 jointly form a converter module (not shown). In other words, each said converter module includes one said unit controller 230 and one said converter 21, so as to simplify the overall circuit configuration.

Please see FIG. 5 in addition. Therein, the computing unit 231 receives the feedback signal FB corresponding to the output voltage Vout (i.e., the working voltage of the load 30), and computes an average voltage Va according to the output voltage Vout (i.e., the working voltage of the load 30) and a number of the converters 21-1, 21-2˜21-n (n) (Step 451). Therein, the average voltage Va is derived from dividing the output voltage Vout by the number of the converters 21-1, 21-2˜21-n (n).

Each said unit controller 230 feedback controls the corresponding converter 21 according to the average voltage Va (Step 453 and Step 455), so as to ensure that each said converter 21 outputs the same constant voltage.

As each said unit controller 230 is configured approximately the same, for the sake of clear illustration, only the schematic structure of one unit controller 230-i is shown, where i is any positive integer between 1 and n.

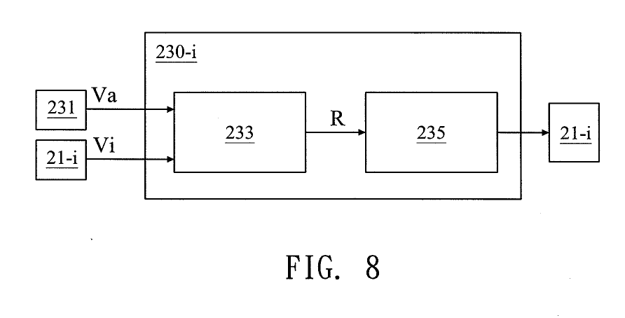

Referring to FIG. 1, FIG. 7 and FIG. 8, the unit controller 230-i may comprise a comparing unit 233 and an optional modulating unit 235. Therein, the comparing unit 233 is electrically connected to the computing unit 231 and the output of the corresponding converter 21-i, and the optional modulating unit 235 is connected between an output of the comparing unit 233 and the corresponding converter 21-i.

Referring again to FIG. 5, the comparing unit 233 of each said unit controller 230-i compares the average voltage Va and the constant voltage Vi from the respectively corresponding converter 21-i (Step 453), and sends a comparison-based result R to the respectively corresponding optional modulating unit 235.

The optional modulating unit 235 of each said unit controller 230-i performs an optional modulation step, wherein a duty cycle of the corresponding converter 21-i is modulated according to the comparison-based result R corresponding to each said converter 21 (Step 455).

Thereby, the present invention implements an internal control unit (i.e., the control circuit 23) to ensure each said converter 21 having the same output power, so as to prevent any of the combined converters 21-1, 21-2˜21-n from getting damaged by its excessive output power.

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A voltage regulator for a fuel cell, comprising:
a plurality of converters, each having an input and an output, wherein the inputs of the converters are electrically connected in parallel to the fuel cell, and the outputs of the converters are electrically connected in series between a positive terminal and a negative terminal of a load; and
a control circuit for controlling the converters according to a working voltage of the load, such that each said converter outputs a same constant voltage.

2. The voltage regulator of claim 1, wherein the control circuit comprises a plurality of unit controllers for respectively corresponding to the converters, and each said unit controller, according to the working voltage of the load, controls the constant voltage output by the corresponding converter.

3. The voltage regulator of claim 2, wherein each said unit controller comprises:
a computing unit for computing an average voltage according to the working voltage of the load and a number of the converters, wherein the average voltage is derived from dividing the working voltage of the load by the number of the converters;
a comparing unit for comparing the average voltage with the constant voltage output by the corresponding converter; and
an optional modulating unit for modulating a duty cycle of the corresponding converter according to a comparison-based result of the comparing unit.

4. The voltage regulator of claim 1, wherein the control circuit comprises:
a computing unit for computing an average voltage according to the working voltage of the load and a number of the converters, wherein the average voltage is derived from dividing the working voltage of the load by the number of the converters; and
a plurality of unit controllers for respectively corresponding to the converters, wherein each said unit controller, according to the average voltage, controls the constant voltage output by the corresponding converter.

5. The voltage regulator of claim 4, wherein each said unit controller comprises:
a comparing unit for comparing the average voltage with the constant voltage output by the corresponding converter; and
an optional modulating unit for modulating a duty cycle of the corresponding converter according to a comparison-based result of the comparing unit.

6. A voltage-regulating method for a fuel cell, comprising steps of:
using a plurality of converters to convert an output of the fuel cell into constant voltages;
combining the constant voltages of the converters into an output voltage; and
performing a feedback control step, wherein the converters are feedback controlled according to the output voltage, such that each said converter outputs a same constant voltage.

7. The voltage-regulating method of claim 6, wherein the feedback control step comprises steps of
computing an average voltage according to the output voltage and a number of the converters, wherein the average voltage is derived from dividing the output voltage by the number of the converters;
comparing the constant voltage output by each said converter with the average voltage; and
performing an optional modulation step, wherein a duty cycle of each said converter is modulated according to a comparison-based result corresponding to the converter.

8. The voltage-regulating method of claim 7, wherein the modulation step comprises steps of:
when the constant voltage is smaller than the average voltage, increasing the duty cycle of the corresponding converter, so as to increase the constant voltage output by the converter to the average voltage;
when the constant voltage is greater than the average voltage, reducing the duty cycle of the corresponding converter, so as to decrease the constant voltage output by the converter to the average voltage; and
when the constant voltage is equal to the average voltage, maintaining the duty cycle of the corresponding converter without change.

9. The voltage-regulating method of claim 7, wherein the optional modulation step implements a PWM (Pulse Width Modulation) control mechanism to increase or decrease the duty cycle of the converter.

10. The voltage-regulating method of claim 6, wherein the output voltage is provided to a load as a working voltage of the load.
